(19) United States
(12) Patent Application Publication
(10) Pub. No.: US 2015/0244408 A1
(43) Pub. Date: Aug. 27, 2015

(54) MOBILE DEVICE JACKET

(71) Applicant: AIMO WIRELESS, INC., City of Industry, CA (US)

(72) Inventor: Ying H. Chen, Chino Hills, CA (US)

(73) Assignee: AIMO WIRELESS, INC., City of Industry, CA (US)

(21) Appl. No.: 14/191,134

(22) Filed: Feb. 26, 2014

(51) Int. Cl. H04B 1/3888

(52) U.S. Cl. CPC H04B 1/3888

(57) ABSTRACT

A jacket for a mobile device, having a retention well with a perimeter wall and a base member, a first perimeter rail surrounding the retention well, a second perimeter rail surrounding the first perimeter rail, a secondary well formed between the first perimeter rail and the second perimeter rail, and a resilient wrapper enveloping the retention well. The resilient wrapper includes a perimeter ridge formed to fit over the second perimeter rail, to fit into the secondary well, and to abut the outer side of the first perimeter rail. A device can have a top cover with a first perimeter rail, a second perimeter rail, and a secondary well, a bottom cover formed to receive the mobile device, and a resilient wrapper including a perimeter ridge to fit over the second perimeter rail, to fit into the secondary well, and to abut the outer side of the first perimeter rail.

### BACKGROUND

1. Field of the Invention

The present invention relates to mobile device covers and, more particularly, to mobile device covers with resilient enclosures.

2. Background

Currently, mobile device covers come in many configurations, such as a hard shell, and more recently, a hard shell with resilient covers. However, with the current resilient covers, gentle force, for example, from a finger, can dislodge the resilient cover, which lessens the shock absorbing qualities provided by the cover. This also allows hard shells to come apart, for example, during a fall. The protection otherwise afforded by a resilient cover can be lost, causing the mobile device, enclosed by the current shell-and-cover configurations, to be damaged perhaps irreparably. What is needed is a mobile device cover that is resistant to dislodgement and can provide mobile device shock protection in the face of everyday forces that are visited upon present mobile device covers.

### SUMMARY

Non-exclusive, non-limiting embodiments of the invention illustrated herein provide a jacket for a mobile device, including a retention well formed to receive the mobile device. The retention well has a perimeter wall and a base member. There is a a first perimeter rail surrounding a portion of the retention well, and a second perimeter rail set apart from and surrounding the first perimeter rail. A secondary well is formed between the first perimeter rail and the second perimeter rail. Also, a resilient wrapper is provided to envelop the retention well. The resilient wrapper includes a perimeter ridge formed to fit over the second perimeter rail, to fit into the secondary well, and to abut the outer side of the first perimeter rail. In this way, the wrapper is securely constrained on the mobile device. In embodiments, the resilient wrapper forms a seal with the second perimeter rail. The cover is formed to retain a mobile phone. The first perimeter rail is taller than the second perimeter rail. Also, embodiments include at least one port through the jacket. Further, a port includes an opening through the jacket bottom formed to accommodate a mobile phone camera. Another port is an opening through the jacket formed to receive a cable. In embodiments, the jacket can include a hinged stand member.

Yet other non-exclusive, non-limiting embodiments provide a cover for a mobile device having a top cover with an upper portion and a lower portion. The upper portion is formed with a first perimeter rail, a second perimeter rail set apart from and surrounding the first perimeter rail, and a secondary well formed between the first perimeter rail and the second perimeter rail. The cover for a mobile device also includes a bottom cover formed to receive the mobile device. The lower portion of the top cover is formed to engage with the bottom cover. The top cover and bottom cover constitute a shell formed to receive the mobile device. The cover for a mobile device further includes a resilient wrapper, which is formed to envelop the bottom cover and a portion of the top cover. The resilient wrapper has a perimeter ridge formed to fit over the second perimeter rail, to fit into the secondary well, and to abut the outer side of the first perimeter rail. The wrapper is securely constrained on the shell. In embodiments, the resilient wrapper engages with the top cover to form an “interlocking J” configuration.

### BRIEF DESCRIPTION OF THE DRAWINGS

The present invention is illustrated by way of example and not by limitation in the accompanying figures, in which like references indicate similar elements, and in which:

FIG. 1 is an exploded perspective view of a shell for a mobile device, in accordance with the teachings of the invention herein;

FIG. 2 is an exploded perspective front view of the shell of FIG. 1 with a resilient wrapper, in accordance with the teachings of the invention herein;

FIG. 3 is a perspective view of a jacket for a mobile device, in accordance with the teachings of the invention herein;

FIG. 4 is a cross-sectional view of the jacket illustrated in FIG. 3, along the 4-4 sectional line, in accordance with the teachings of the invention herein;

FIG. 5 is an exploded, perspective rear view of the shell of FIG. 1 with the resilient wrapper, in accordance with the teachings of the invention herein; and

FIG. 6 is the reverse view of FIG. 3, in accordance with the teachings of the invention herein.

Skilled artisans appreciate that elements in the figures are illustrated for simplicity and clarity and have not necessarily been drawn to scale. For example, the dimensions of some of the elements in the figures may be exaggerated relative to other elements to help improve the understanding of the embodiments of the present invention.

### DETAILED DESCRIPTION

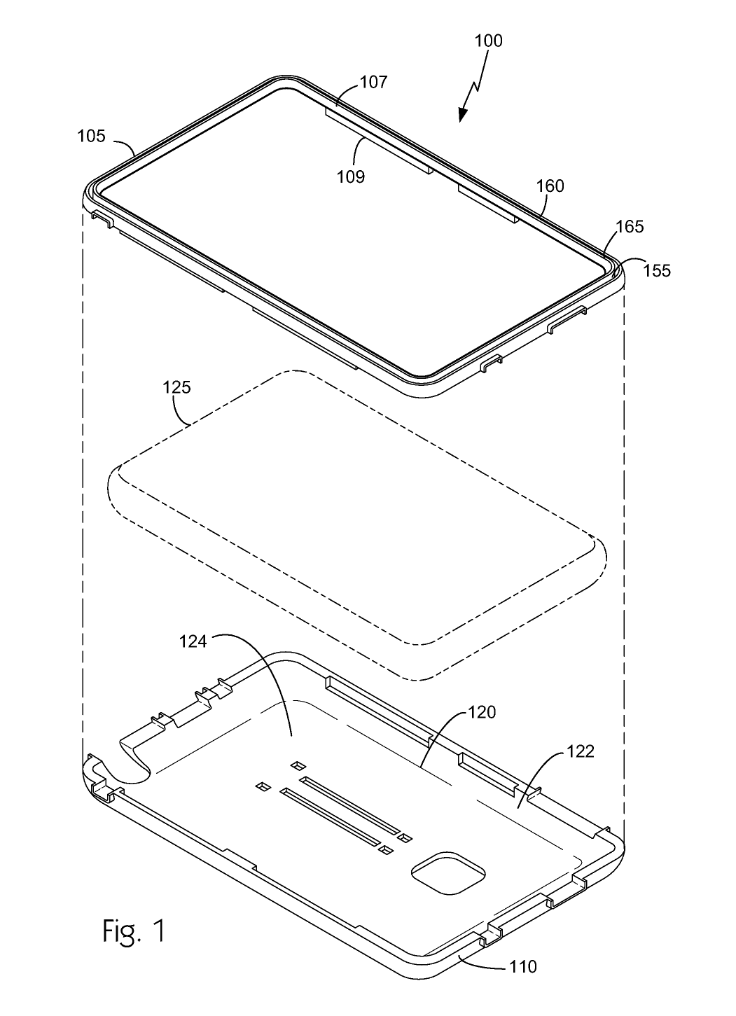

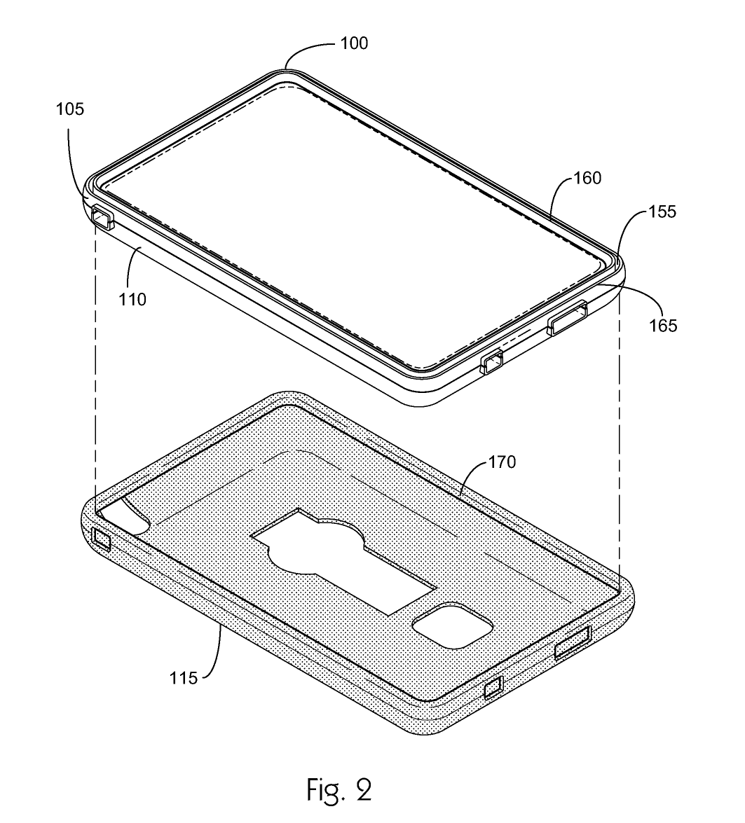

FIGS. 1 and 2 illustrate device jacket 102, which includes top cover 105, bottom cover 110, and wrapper 115. In FIG. 1, top cover 105 and bottom cover 110 can be oriented relative to the user interface side 127 of electronic device 125. Electronic device 125 can be a mobile device, a wireless device, or both—a mobile, wireless device. As used herein, “mobile device” can be used synonymously with a mobile, wireless device. Top cover 105 can be made of a hard yet flexible material such as a plastic or a metal. Bottom cover 110 also can be made of a hard yet flexible material such as a plastic or a metal. Top cover 105 can be formed to retain device 125 within retention well 120. Together, top cover 105 and bottom cover 110 may constitute shell 100. Shell 100 can be formed to receive mobile device 125. Shell 100 may snugly retain device 125. Shell 100 can provide shock absorbance for electronic mobile device 125.

Bottom cover 110 can constitute a retention well 120 formed to receive mobile device 125. Retention well 120 of bottom cover 110 is formed by base member 124 surrounded by perimeter wall 122. Top cover 105 can have an upper portion 107 and a lower portion 109. Upper portion 107 of top cover 105 can have a first perimeter rail 160 surrounding at least a portion of retention well 120. Upper aspect 107 also can have a second perimeter rail 165 set apart from and surrounding first perimeter rail 160. Secondary well 155 can be formed between first perimeter rail 160 and second perimeter rail 165. First perimeter rail 160 can be taller than second perimeter rail 165. Lower portion 109 can be formed to engage with perimeter wall 122 of bottom cover 110. As shown in FIG. 2, top cover 105 and bottom cover 110 can be formed to be joined, for example, by a snap-fit.

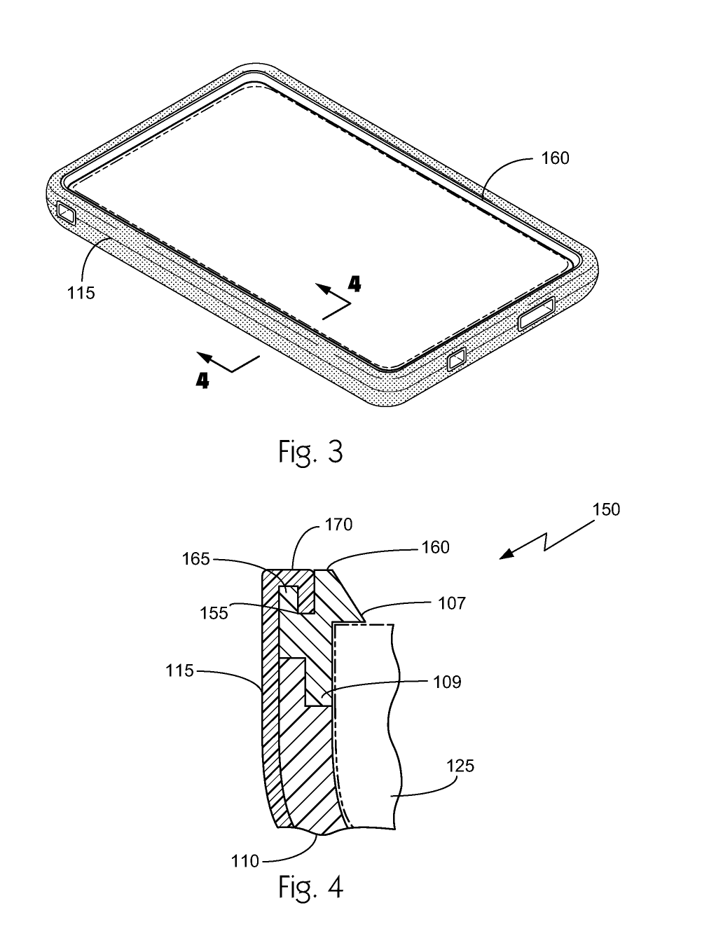

FIG. 3 depicts wrapper 115 enveloping bottom cover 110 and a portion of top cover 105, thereby forming device jacket 102. Wrapper 115 can have a perimeter ridge 170. Perimeter ridge 170 of wrapper 115 can be formed to fit over second perimeter rail 165, to fit into the secondary well 155, and to abut first perimeter rail 160. Wrapper 115 may be made of a resilient material, such as an elastomeric material, which can absorb the shock of a bump to, or of a fall of, electronic device 125. In concert with shell 100, wrapper 115 can provide shock absorbance for electronic mobile device 125.

In FIG. 4, cross section 150 of device jacket 102 in FIG. 3 is shown. Upper aspect 107 of top cover 105 can be seen to have first perimeter rail 160 and second perimeter rail 165, with secondary well 155 being disposed therebetween. The cross-section profile of the upper aspect 107 of top cover 105 can be formed to have generally an upright J-shape. The cross-section profile of wrapper 115 is depicted to have a generally an inverted J-shape, which can be formed to tightly interlock with the upright J-shape of top cover 105. The “interlocking J” configuration can securely constrain jacket 102 on device 125. The “interlocking J” configuration also may provide device 125 with additional protection against shock and damage, for example, by preventing shell 100 from separating, and exposing device 125. In general, the interlocking configuration resists casual or accidental separation of wrapper 115 from shell 100. Other interlocking configurations may be used, for example, without limitation, a U-shaped or a V-shaped interlocking configuration. Wrapper 115 is illustrated to envelop bottom cover 110 and a portion of top cover 105. Wrapper 115 can be formed to hold top cover 105 and bottom cover 110 together using at least some tension as may be produced by the resilient material of wrapper 115. Typically, the resilient wrapper forms a seal with the second perimeter rail.

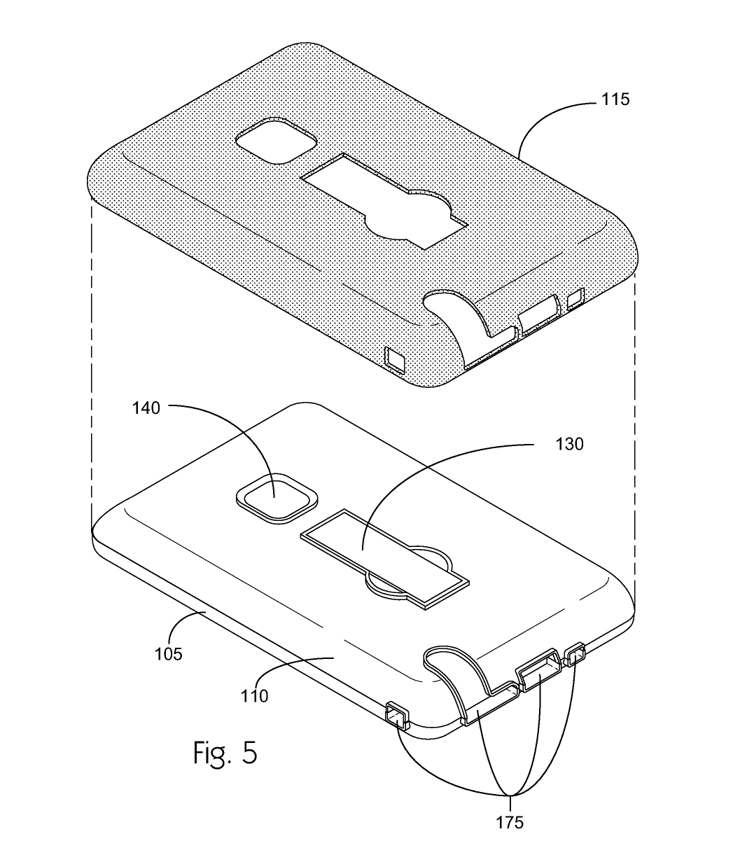

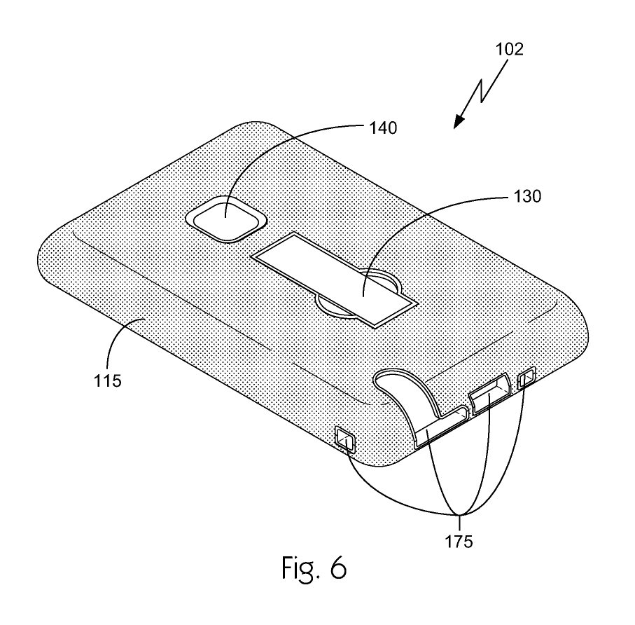

FIG. 5 is an exploded rear view of bottom case 110 and wrapper 115. Typically, top cover 105 and bottom cover 110 form openings generally at 175, which can complement functional ports in device 125, such as a power/recharge port, an audio port, a USB port, an HDMI port, or other functional element port of device 125. In addition, the bottom of jacket 102 may include opening 140, as may be used for an element of device 125, for example, a camera. Further, the rear of bottom cover 110 can be formed to include an optional sliding ramp-type stand 130 which, when deployed, allows a user to dispose device 125 in a generally upright position. The side profile of stand 130 attached to bottom cover 110 may assume an A-shape, when stand 130 is extended. FIG. 6 illustrates an assembled jacket 102, as seen from the rear. FIG. 6 can be understood as the reverse side mobile device jacket 102 of FIG. 3, rotated by 180 degrees.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention, as defined by the appended claims.

1. A jacket for a mobile device, comprising:
a retention well formed to receive the mobile device and having a perimeter wall and a base member;
a first perimeter rail surrounding a portion of the retention well;
a second perimeter rail set apart from and surrounding the first perimeter rail;
a secondary well formed between the first perimeter rail and the second perimeter rail; and
a resilient wrapper formed to envelop the retention well, wherein the resilient wrapper includes a perimeter ridge formed to fit over the second perimeter rail, to fit into the secondary well, and to abut the outer side of the first perimeter rail, wherein the wrapper is securely constrained on the mobile device.

2. The jacket of claim 1, wherein the resilient wrapper forms a seal with the second perimeter rail.

3. The jacket of claim 1, wherein the cover is formed to retain a mobile phone.

4. The jacket of claim 1, wherein the first perimeter rail is taller than the second perimeter rail.

5. The jacket of claim 3, wherein the retention well further comprises at least one port through the jacket.

6. The jacket of claim 5, wherein at least one port comprises an opening through the jacket bottom, which is shaped to accommodate a mobile phone camera.

7. The jacket of claim 6, wherein at least one port further comprises an opening through the jacket formed to receive a cable.

8. The jacket of claim 7 further comprising a hinged stand member deployable through the resilient wrapper.

9. The jacket of claim 1, wherein the retention well further comprises at least one port through the device jacket.

10. The jacket of claim 9, wherein at least one port comprises an opening through the jacket formed to receive a cable.

11. The jacket of claim 9, wherein at least one port comprises an opening through the jacket formed to accommodate a camera lens.

12. A mobile device cover, comprising:
a top cover having an upper portion and a lower portion, wherein the upper portion is formed with a first perimeter rail, a second perimeter rail set apart from and surrounding the first perimeter rail, and a secondary well formed between the first perimeter rail and the second perimeter rail;
a bottom cover formed to receive a mobile device, wherein the lower portion of the top cover is formed to engage with the bottom cover, and wherein the top cover and bottom cover constitute a shell formed to receive the mobile device; and
a resilient wrapper formed to envelop the bottom cover and a portion of the top cover, wherein the resilient wrapper includes a perimeter ridge configured to fit over the second perimeter rail, to fit into the secondary well, and to abut the outer side of the first perimeter rail, wherein the wrapper is securely constrained on the shell.

13. The cover of claim 12, wherein the resilient wrapper engages with the top cover to form an “interlocking J” configuration.
